(19) United States
(12) Patent Application Publication
(10) Pub. No.: US 2014/0096162 A1
(43) Pub. Date: Apr. 3, 2014

(54) Automated Social Media and Event Driven Multimedia Channels

(71) Applicant: CENTURYLINK INTELLECTUAL PROPERTY LLC, Denver, CO (US)

(72) Inventors: Steven M. Casey, Littleton, CO (US); Felipe Castro, Erie, CO (US); Ronnie S. Dhaliwal, Centennial, CO (US); Hong Hee Choi, Denver, CO (US)

(73) Assignee: CENTURYLINK INTELLECTUAL PROPERTY LLC, Denver, CO (US)

(21) Appl. No.: 13/631,110

(22) Filed: Sep. 28, 2012

(51) Int. Cl. H04N 21/472; G06F 17/30

(52) U.S. Cl. 725/61; 725/87

(57) ABSTRACT

Novel tools and techniques are described for generating or extracting keywords based on trend data related to contemporary news events, social media topics, and/or Internet searches, etc. Local and/or remote content catalogs, which are respectively associated with local and remote content libraries, are searched for relevant multimedia content (e.g., video, audio, and/or written content) using the generated or extracted keywords. Dynamic automated on-demand and/or broadcast channels are generated that incorporate the relevant multimedia content, and streamed and/or broadcast to one or more user devices (including PCs, televisions, and mobile devices). User-interactive selection capabilities are optionally provided during the channel generation process.

The present disclosure relates, in general, to streaming and/or broadcasting multimedia channels, and more particularly, to automatically generating multimedia channels for streaming and/or broadcasting, said channels being driven by social media, news events, and Internet searches, etc.

### BACKGROUND

Conventionally, audio and video content has been delivered in broadcast format, grouped by channels. As delivery systems have matured, an increasing amount of content has been made available on-demand. Nonetheless, subscribers are accustomed to the channel-based model of content delivery, and channels can serve a valuable function as signaling devices for particular content (e.g., a subscriber knows which channel carries his or her favorite program) and as indicators of content (e.g., the Food Network™ carries programming about food). Accordingly, the channel model remains a popular mode for delivering content with distribution systems (such as cable television, satellite television, Internet Protocol television (“IPTV”), and the like). As such, different ways have been developed for putting on-demand content in sequence on a channel, as understood by those skilled in the art.

Due to the prevalence of social media, millions of people are now exposed to current events, more so than before the advent of social media, and certainly before the Internet became popular. However, information and content about the current events are spread across countless webpages, on-line news websites, social media postings, etc. Accordingly, it is difficult for a user who is interested in keeping current with news events, social media, and/or Internet searches, etc., to easily view related videos, listen to relevant audio, and/or read applicable writings in order to stay abreast with “What's Hot Now.”

Currently, trending data is available on the web, to indicate which current events have captured the attention of the online community (and serve as a proxy for indicating which events are popular with the population generally). One of the most used systems is Google® Trends™, which displays an hourly, daily, weekly, monthly, and yearly display of what topics generate the most searches on the web. By using this data, a person can see what topics are of most interest on the web (and across popular media as well). Unfortunately, this is a lean-forward process. A user would still need to follow the search links or perform additional searches for multimedia content in order to learn more about the searched topic(s) or to view, listen to, and/or read related multimedia content.

Accordingly, there is a need for more robust systems to allow subscribers access to content about currently-popular topics and/or events.

### BRIEF SUMMARY

An aspect of the present disclosure seeks to address the problems noted above, for example, by using Internet and news trends to automatically build video (or multimedia) channels based on what the population is most interested in that day or hour. A simple example of this would be taking results from Google® Trends™ and putting together one or more video (and/or multimedia) channels around the results. In an aspect, some embodiments identify the most searched for topics on the Internet and then collect and/or channelize audio, video, and text data (i.e., multimedia content) that are related to those topics. In different aspects, these channels can be delivered using conventional television distribution techniques, such as cable television distribution systems, satellite television distribution systems, and/or IPTV distribution systems.

According to various embodiments, a system can process data concerning topical popularity and then collect the video, audio, and/or written content (i.e., “multimedia content”) around such topics. This content can be compiled into a television or interactive channel (e.g., on-demand or broadcast channel). For example, this process could be implemented as a specific set of channels on the Prism® (IPTV™) system that CenturyLink® offers today. A customer could watch this channel to see what is going on in his or her area or in the rest of the world. There could also be specific categories for each channel. For example, there could be a “What's Hot in Entertainment” channel, which shows movies, biographical videos, and the like, based on what people are currently searching for. Alternatively, a channel might be provided concerning sports, which could have the top search trends for that day, with highlight clips as well, scores, and the like.

Such programming can be integrated into subscription video systems (e.g., cable, satellite, IPTV) as part of a new channel package. Such content could also be provided by any appropriate mobile video system or any other commercially available multimedia broadcast or on-demand content delivery systems that have a data connection (e.g., video viewable on a mobile device or other commercially available TV systems).

In an exemplary aspect of the disclosure, methods and systems are described for creating automated social media and/or event driven multimedia channels. In this exemplary aspect, such methods and systems can leverage current events, social media postings, news breaks (e.g., in the form of clips, headlines, stories, etc.), when the events occur, and can generate specialized multimedia channels. In generating these specialized multimedia channels, these solutions can access trend data representing contemporary social media, Internet searches, and/or news events, and can generate keywords based on the trend data. Multimedia content libraries can be searched to find multimedia content (e.g., video content, audio content, written content, etc.) that are relevant to the generated keywords.

Once the multimedia content are found, the system might generate at least one dynamic automated on-demand channel for streaming the relevant multimedia content, based on the list of relevant multimedia content. In some embodiments, the system is configured to display a selection screen on the at least one dynamic automated on-demand channel from which the user is enabled to select a program of the relevant multimedia content for streaming.

In addition, or in the alternative, the system might generate at least one dynamic automated broadcast channel, as well as a programming schedule of the relevant multimedia content based on particular predetermined criteria (including, but not limited to, at least one of relevance, user preference, popularity, age of viewers, length of multimedia content, subject matter of multimedia content, and broadcaster's program scheduling policies). The relevant multimedia content might then be broadcast to a plurality of users on the at least one dynamic automated broadcast channel based on the generated programming schedule.

According to some embodiments, the program of relevant multimedia content (i.e., streamed content) can be formatted at the server of the telecommunications system—which may include one or more of a server at a head-end of the telecommunications system, a server located external to the head-end yet communicatively coupled to the head-end, a server located at a broadcast television distribution system, and a server located external to the broadcast television distribution system yet communicatively coupled thereto—for presentation on at least one user device. The at least one user device may include at least one of a cable television system, an interactive television system, a standard television system, an Internet Protocol television system, a gaming console, a mobile device, a personal computer, and a tablet computer.

In some embodiments, the broadcast relevant multimedia content (i.e., broadcast content) is formatted at the server for presentation on the at least one user device.

The specialized channel might last any number of days, weeks, months, years, or longer. The discovery process (in which the multimedia content is compiled based on the trend data of contemporary social media, Internet searches, and/or news events) might occur without human intervention, while the scheduling of the dynamic automated on-demand and/or broadcast channel might allow for some operator intervention.

The exemplary method and system would allow for the display of a selection screen that presents video clips, audio clips, and/or textual clips that represent the current trends of the hour, day, month, year, etc. (i.e., “What's Hot”), so that the user may select one or more of these video clips, audio clips, and/or textual clips for presentation on one or more user devices (e.g., mobile devices, computers, TVs, etc.). An alternative exemplary method and system could allow for the scheduling of a broadcast channel(s) that compiles said video clips, audio clips, and/or textual clips in a format similar to conventional TV broadcasts, and then broadcasts the channel(s) for viewing on the one or more user devices (e.g., mobile devices, computers, TVs, etc.).

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a generalized system diagram illustrating an aspect 100 of an automated social media and event driven multimedia channel system, in accordance with various embodiments.

FIG. 2 is a process flow diagram illustrating another aspect 200 of the automated social media and event driven multimedia channel system, in accordance with various embodiments, with a focus on information aggregation, keyword extraction, content lookup, and content presentation.

FIG. 3 is a flow chart illustrating the process 300 of generating and presenting an automated social media and event driven multimedia channel, in accordance with various embodiments.

FIGS. 4A-4C represent a system flow diagram 400 illustrating the processes performed at or by components of the system in order to generate and present an automated social media and event driven multimedia channel, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various aspects of the present disclosure are directed to identifying news events, social media topics, and/or Internet searches, etc., that capture the current attention of a particular, or a general, group of people (whether in a local region or around the world). This identification may be accomplished by using third party services, such as Google® Trends™, to generate trend data and/or might be performed using only system components and/or methodologies. Keywords can then be extracted from the trend data, and local and/or remote content catalogs can be searched using the keywords. Once relevant multimedia (i.e., video, audio, and/or written) content is found in either the local and/or remote content catalogs, which are respectively associated with local and remote databases (“databases” or “DBs”), the relevant content may be retrieved from the local and/or remote database(s), and compiled in on-demand or broadcast channels that are then formatted and presented on one or more user device(s) (including, but not limited to, personal computers, laptops, televisions, mobile devices, etc.).

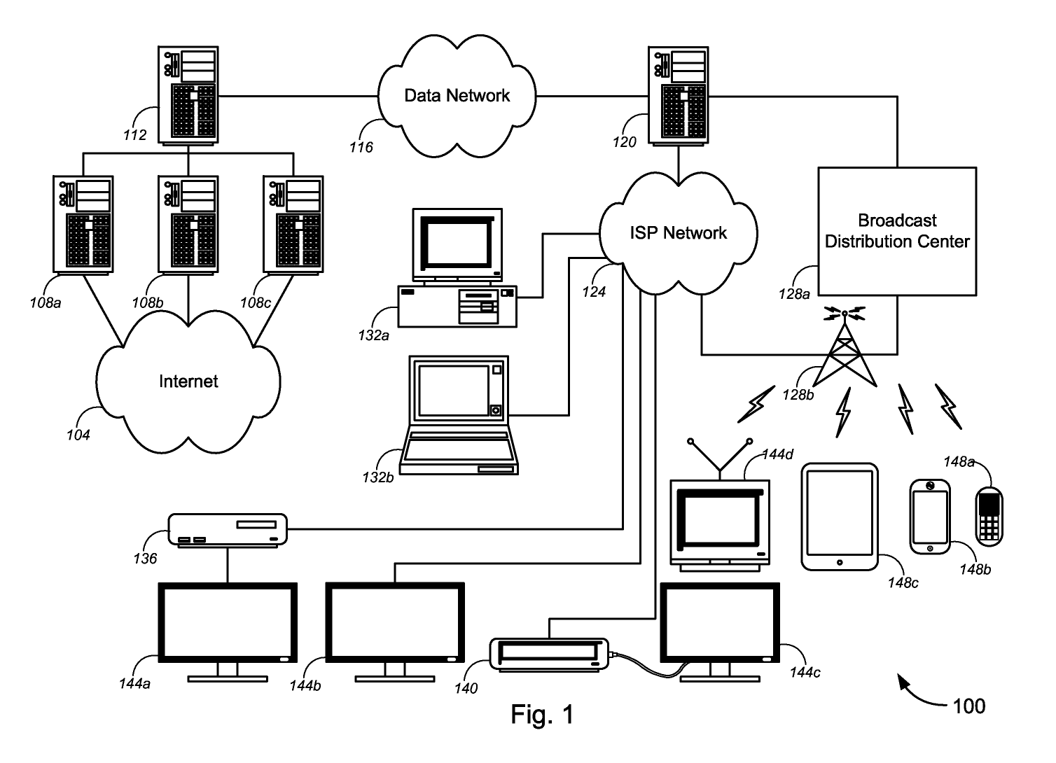

With reference to FIG. 1, a generalized system diagram is shown illustrating an aspect 100 of an automated social media and event driven multimedia channel system, in accordance with various embodiments. In system 100, Internet 104 represents any network (of which the Internet is an example) containing the source of applicable social media postings, news reports of events, Internet searches, etc. Aggregators 108—including social media aggregator 108a, news event aggregator 108b, and Internet search aggregator 108c, which are communicatively coupled to the Internet 104—collect or compile current social media postings, news reports of events, Internet searches, etc. Trend data server 112, which may be communicatively coupled directly to aggregators 108 or indirectly coupled to aggregators 108 via a network (e.g., the Internet 104 or some other network (not shown)), generates trend data based on the current social media postings, news reports of events, Internet searches, etc. that are collected and compiled by aggregators 108. An example of trend data server 112 is the server or collection of servers that provide the Google® Trends™ service.

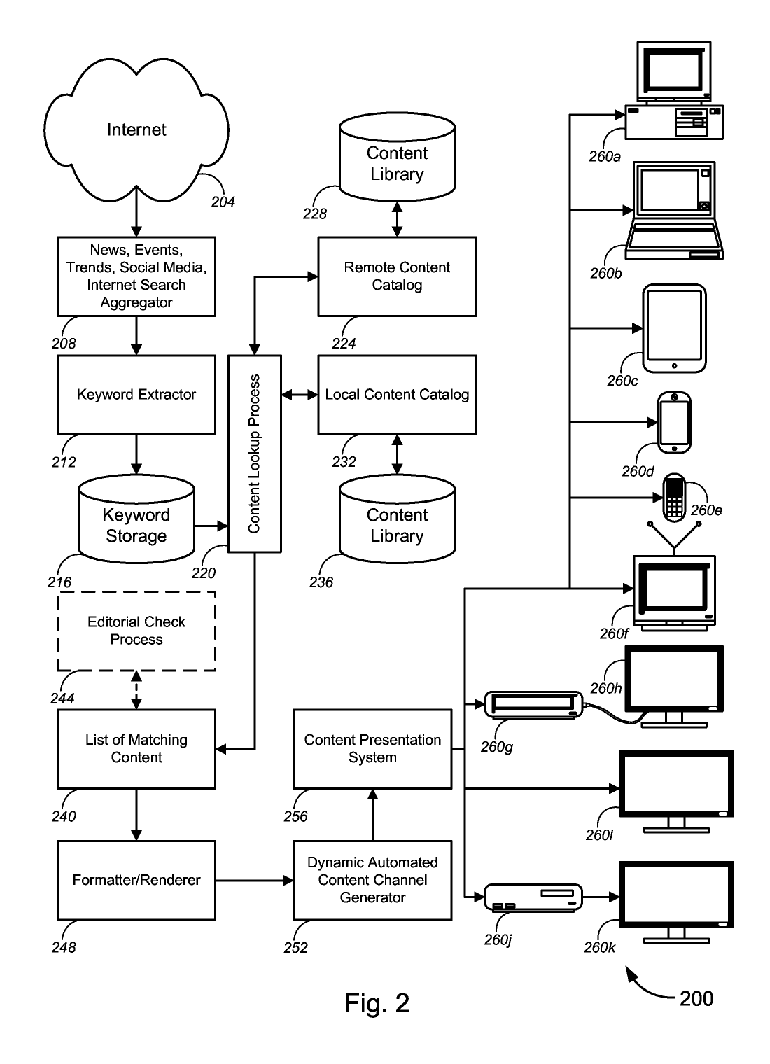

Through data network 116, the trend data is utilized by automatic channel generator or server 120. The process of generating a multimedia channel based on the trends of social media, news events, and Internet searches is described in greater detail below with reference to FIGS. 2-4C. For the purposes of FIG. 1, the automatic channel generator or server 120 generates a multimedia channel(s) which may be presented to a user on a user device(s) either as an on-demand channel(s) and/or a broadcast channel(s).

For presentation as an on-demand channel(s), server 120 generates a selection screen(s) and displays the selection screen(s) to a user computer 132 or a user television 144 via an Internet Service Provider (“ISP”) network 124. User computer 132 may include one or more personal computers (“PCs”) 132a, one or more laptop computers 132b, and/or any other general-purpose computing devices. User television 144 may include one or more of any of a high-definition (“HD”) television 144a, an IPTV 144b or Connected TV/Smart TV/Hybrid TV 144b, and a cable television 144c, where any or all of HD TV 144a, IPTV 144b, Connected TV/Smart TV®/Hybrid TV 144b may be interactive TVs. Any of these televisions 144 may be coupled to the network 124 via a gaming console 136 and/or via a set-top box (“STB”) 140. In some embodiments, network 124 may be communicatively coupled to a transmission tower 128b, which would transmit the selection screen(s) to a user's mobile device 148 (including, e.g., mobile phone 148a, smartphone 148b, and tablet computer 148c). In response to a user selection via any of the user devices (i.e., computer 132, television 144, etc.), server 120 would generate a dynamic automated on-demand channel(s) and transmit the channel via network 124 (and perhaps also via tower 128b) to the requesting user device(s). Although network 124 is shown as an ISP network, network 124 may be embodied as any type of content distribution network (including, but not limited to, an ISP network, a satellite network, a cable television network, etc.).

For presentation as a broadcast channel(s), server 120 would generate a programming schedule based on the trend data and collection of available and relevant content (which is described in detail with respect to FIGS. 2-4C below). Server 120 would subsequently generate a dynamic automated broadcast channel(s) based on the generated programming schedule, and transmit to broadcast distribution center 128a and tower 128b (collectively, “broadcast system 128”) for broadcast on a user television (such as television 144d) and mobile devices 148 (including, but not limited to, mobile phone(s) 148a, smartphone(s) 148b, and tablet computer(s) 148c). In FIG. 1, although tower 128b is shown as a single transmission tower connected to both the network 124 and the broadcast distribution center 128a, tower 128b may be two or more towers that are each connected to only one of network 124 and broadcast distribution center 128a.

The system 100 can include one or more user computers 132. A user computer 132 can be a general purpose personal computer or PC (including, merely by way of example, desktop computers, tablet computers, laptop computers, handheld computers, and the like, running any appropriate operating system, several of which are available from vendors such as Apple Inc., Microsoft Corp., and the like) and/or a workstation computer running any of a variety of commercially-available UNIX™ or UNIX-like operating systems. In FIG. 1, although user computer 132 is shown as including PC 132a and laptop computer 132b, user computer 132 may also include tablet computer 148c or any other mobile device such as smartphone 148b or mobile phone 148a.

A user computer 132 can also store and/or execute any of a variety of applications, including one or more applications configured to perform operations in accordance with methods provided by various embodiments (as described above, for example), as well as one or more office applications, database client and/or server applications, and/or web browser applications. Alternatively, a user computer 132 can be any other electronic device, such as a thin-client computer, Internet-enabled mobile telephone, and/or personal digital assistant, capable of communicating via a network (e.g., the network 124 described below) and/or of displaying and navigating web pages or other types of electronic documents. Although the exemplary system 100 is shown with two user computers 132 and one tablet computer 148c, any number of user computers can be supported.

The network 124 (and perhaps also networks 104 and 116) can be any type of network familiar to those skilled in the art that can support data communications using any of a variety of commercially-available (and/or free or proprietary) protocols, including without limitation TCP/IP and the like. Merely by way of example, the network 124 (or networks 104 and 116) can include a local area network (“LAN”), including without limitation a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks. Alternatively, networks 104 and 116 may be embodied as one network separate from network 124. In some embodiments, networks 116 and 124 may be embodied as one network separate from network 104. In other embodiments, networks 104, 116, and 124 may be embodied as one network.

Embodiments can also include one or more server computers 120 (or server computers 108 and 112). Each of the server computers 120 may be configured with an operating system, including without limitation any of those discussed above, as well as any commercially (or freely) available server operating systems. Each of the servers 120 may also be running one or more applications, which can be configured to provide services to one or more clients 132, 136, 144, and 148 and/or other servers 120.

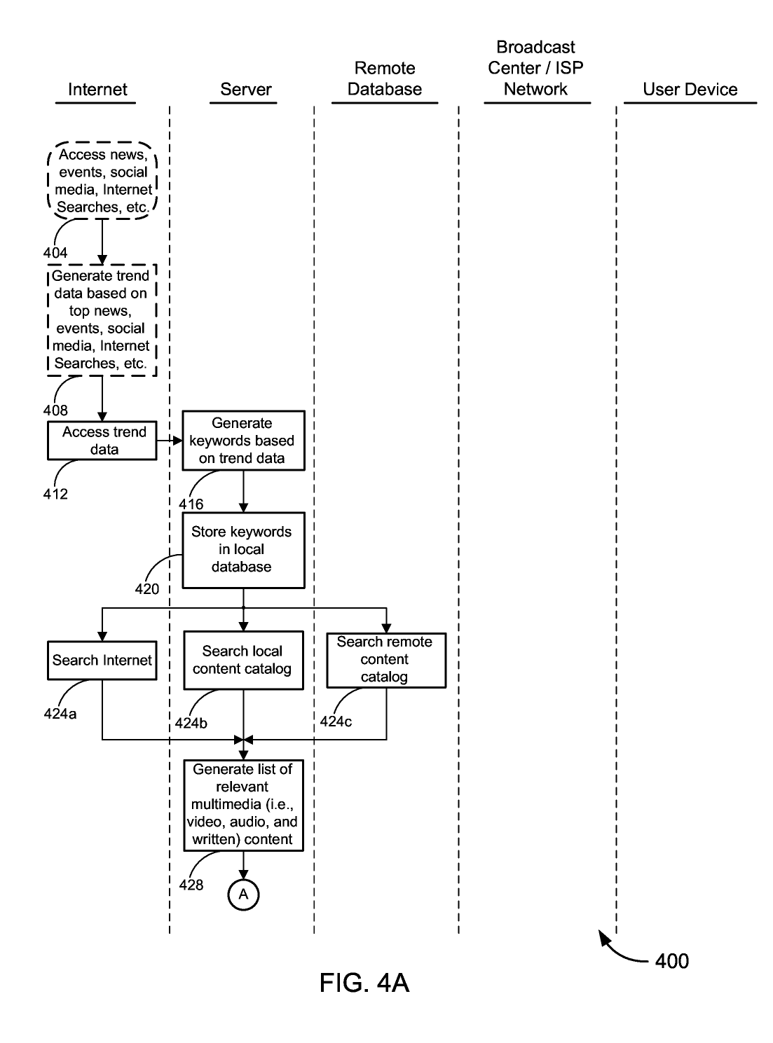

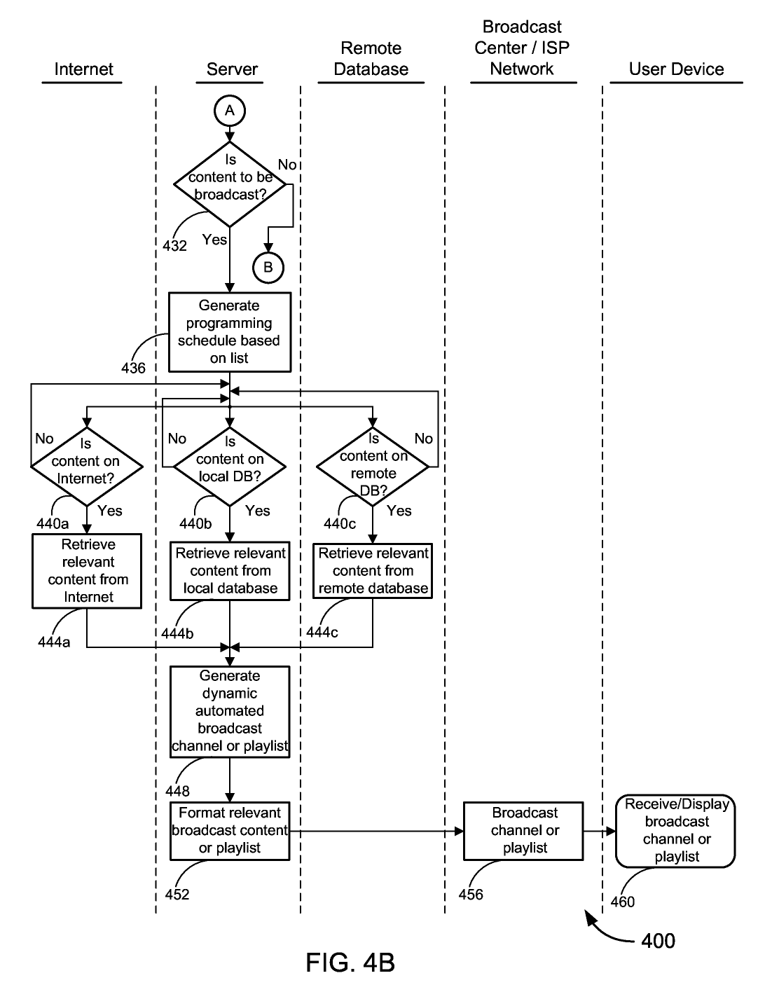

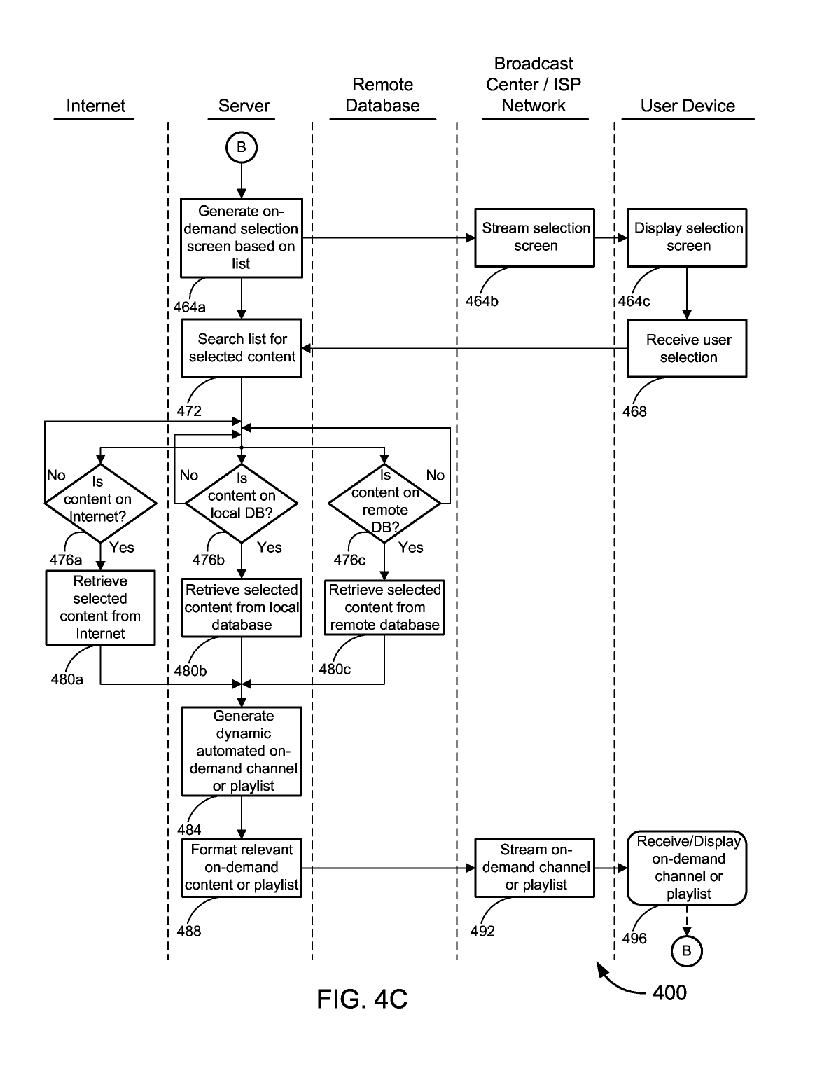

Merely by way of example, one of the servers 120 may be a web server, which can be used, merely by way of example, to process requests for web pages or other electronic documents from user computers 132 or mobile devices 148. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 132 or mobile devices 148 to perform methods of the invention. The servers 120 may also function as a middleware server that provides content. For example, as discussed in greater detail with respect to FIGS. 2 and 4, middleware servers may include a server for accessing trend data (e.g., module used in Block 412), a server for extracting keywords (e.g., keyword extractor 212), a content lookup server (e.g., content lookup process module 220), a server functioning as a content catalog (e.g., remote content catalog 224 and local content catalog 232), a content matching server (e.g., list generator 240 for matching content), an editorial check process facilitating server (e.g., editorial check process module 244), a formatting server (e.g., formatting module 248, module used in Blocks 452 and 488, etc.), a program schedule generating server (e.g., module used in Block 436), a content location/retrieval server (e.g., modules used in Blocks 424, 440, 444, 476, and 480), a channel generating server (e.g., dynamic automated content channel generator 252), a playlist generating server (e.g., module used in Blocks 448 and 484), a content presentation server (e.g., a content presentation system module 256, module used in Blocks 456 and 492, etc.), among other middleware servers. Some of the above-mentioned middleware servers may be embodied as one or more integrated or consolidated middleware servers that incorporate several functionalities into single servers. In addition, databases (e.g., keyword storage 216, remote content library 228, and local content library 236) may be embodied as middleware or database servers.

The server computers 120, in some embodiments, might include one or more application servers, which can be configured with one or more applications accessible by a client running on one or more of the client computers 132 and/or other servers 120. Merely by way of example, the server(s) 120 can be one or more general purpose computers capable of executing programs or scripts in response to the user computers 132 and/or other servers 120, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer 132 and/or another server 120. In some embodiments, an application server can create web pages dynamically for displaying the information in accordance with various embodiments, such as displaying a selection screen for an on-demand channel(s) as a web page(s). Data provided by an application server may be formatted as one or more web pages (comprising HTML, HTML5, JavaScript, etc., for example) and/or may be forwarded to a user computer 132 via a web server (as described above, for example). Similarly, a web server might receive web page requests and/or input data from a user computer 120 and/or forward the web page requests and/or input data to an application server. In some cases, a web server may be integrated with an application server.

In accordance with further embodiments, one or more servers 120 can function as a file server and/or can include one or more of the files (e.g., application code, data files, etc.) necessary to implement various disclosed methods, incorporated by an application running on a user computer 132 and/or another server 120. Alternatively, as those skilled in the art will appreciate, a file server can include all necessary files, allowing such an application to be invoked remotely by a user computer 132 and/or server 120.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases including, but not limited to, databases or DBs 216, 228, and 236, as described in greater detail with respect to FIG. 2. The location of the database(s) 216, 228, and 236 is discretionary: merely by way of example, databases 216 and 228 might reside on a storage medium local to (and/or resident in) a server 120. Alternatively, a database 236 can be remote from any or all of the servers 120 or computers 132, so long as it can be in communication (e.g., via the network 116 or 124 or similar network) with one or more of these. In a particular set of embodiments, a database 236 can reside in a storage-area network (“SAN”) familiar to those skilled in the art. In one set of embodiments, the database 236 can be a relational database, such as an Oracle database, that is adapted to store, update, and retrieve data in response to SQL-formatted commands. The database might be controlled and/or maintained by a database server, as described above, for example.

In addition, various user devices (including, but not limited to, PC 132a, laptop 132b, gaming console 136, STB 140, HD TV 144a, IPTV 144b or Connected TV/Smart TV®/Hybrid TV 144b, tablet computer 148c, smartphone 148b, and mobile phone 148a, etc.) might also include a communications subsystem (not shown), which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem may permit data to be exchanged with a network (such as the networks described above, to name one example), with other computer systems, and/or with any other devices described herein.

Referring to FIG. 2, a process flow diagram is shown illustrating another aspect 200 of the automated social media and event driven multimedia channel system, in accordance with various embodiments, with a focus on information aggregation, keyword extraction, content lookup, and content presentation. In FIG. 2, Internet 204 could be the same as Internet 104, as described above with reference to FIG. 1. Aggregator 208 may be a combination of aggregator 108 and trend data server 112, as described with respect to FIG. 1, or might be a separate device that aggregates content and information from social media postings, from news articles and clips, and/or from Internet searches, and subsequently generates trend data based on one or more of these pieces of content and information. Keyword extractor 212, which may be embodied in server 120 or in any other server or system component (not all of which are shown in FIG. 2), extracts or generates keywords from trend data obtained, based on the information gathered by aggregator 208 (and/or trend data server 112). For example, keyword extractor 212 might eliminate any articles (such as “the,” “a”), pronouns (e.g., “he,” “she,” “it,” “they,” etc.), and/or connector words (e.g., “and,” “or,” etc.) from the trend data, while compiling place names, names of persons (both proper names and nicknames), names of companies (including name under which a corporation is incorporated with a Secretary of State, the name under which a business is organized with a Secretary of State, the name that a company is doing business as (i.e., “d/b/a”), etc.), and/or key terms [including, but not limited to, weather-related terms (e.g., “hurricane,” “tornado,” “flood,” “earthquake,” etc.), sports-related terms (e.g., “All-Star game,” “World Series,” “Olympics,” “Super Bowl,” etc.), technology-related terms (e.g., “OLED,” “4G,” “near field communication (NFC),” etc.), electronics-related terms (e.g., “iPhone 5,” Samsung Galaxy S III,” “E3,” “Wii U,” “Xbox 720,” “PlayStation 4”, etc.), etc.] from the trend data. The names and/or key terms (and variants thereof) might be compiled in a list of terms. In some embodiments, the keyword extractor 212 may narrow this list of terms based on predetermined criteria (including, but not limited to, at least one of popularity, age of user, subject matter, and policies of the service provider that controls the keyword extractor). According to some embodiments, user preferences (including, user “likes,” “dislikes,” and other saved preferences) are stored or otherwise taken into account, and the keyword extractor might further narrow the list of terms based on these user preferences.

The extracted or generated keywords (or list of terms or narrowed list of terms) may be stored in keyword storage or database 216. In some embodiments, there may not be a need to store the keywords prior to searching for relevant content based on the keywords. During the content lookup process 220, the keywords are used to search either a local content catalog 232 or a remote content catalog 224, or both catalogs, for relevant multimedia content (including, but not limited to, video content, audio content, and/or written content, etc.). Once relevant content has been found, based on the keywords, a list of matching content 240 is compiled.

For an on-demand channel(s), an optional editorial check process 244 may be implemented, perhaps by a human operator at the service provider end or by an automated program, to check the layout of a selection screen(s). For a broadcast channel(s), the optional editorial check process 244 may be implemented in like fashion to check the program schedule(s) for the broadcast channel(s).

Once the content has been selected, in the case of the on-demand channel(s), or a program schedule has been generated, in the case of the broadcast channel(s), the relevant video, audio, and/or textual content is retrieved from either the remote content library 228 and/or the local content library 236 (based on the search of the remote and local content catalogs 224 and 232, respectively, and/or based upon the generated list 240). The retrieved relevant content is then formatted for display or presentation on one or more user devices 260 by formatter/renderer 248. For example, for user devices capable of high definition (“HD”) display, such as (but not limited to) IPTV 260i, formatter/renderer 248 (hereinafter, the “formatter,” “formatter/renderer,” or “renderer”) may format the channel(s) or render graphics or content of the channels for optimal display on an HD display screen (such as 1080i MPEG2). Formats may also include, for example, 640×480 MPEG2 or 1024×768 MPEG4 formats, or any other formats suitable for display or presentation of the multimedia content on mobile devices. Formatter 248 may also format and/or render a selection screen, an electronic program guide (the “EPG”), a broadcast program guide, and/or a playlist for display or presentation on the one or more user devices 260. Formatting or rendering the content of the channels or the graphical displays of the selection screen, the EPG, the broadcast program guide, and/or the playlist for the one or more user devices 260 associated with the user can comprise producing a bitmap and/or other graphical image corresponding to the content (e.g., visual and/or textual content), the display characteristics (e.g., screen resolution), and/or user input devices supported by the one or more user devices 260.

Dynamic automated content channel generator 252 generates on-demand and/or broadcast channel(s) or playlist(s) using the retrieved and formatted/rendered relevant content. The on-demand and/or broadcast channel(s) are then transmitted to one or more user devices 260 via content presentation system 256. User devices 260 may include one or more of PC 260a, laptop computer 260b, tablet computer 260c, smartphone 260d, mobile phone 260e, standard television 260f, STB 260g and cable television 260h, HD television or IPTV or interactive TV 260i, gaming console 260j, and HD TV or IPTV or interactive TV 260k. Each of user devices 260a-260k may be implemented as single units or multiple units.

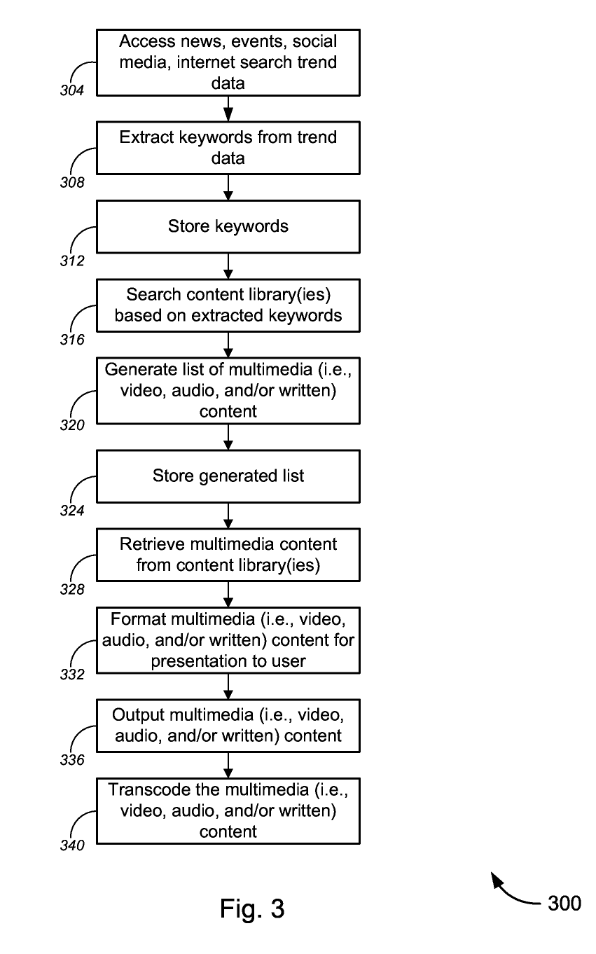

Turning to FIG. 3, a flow chart is shown illustrating the process 300 of generating and presenting an automated social media and event driven multimedia channel, in accordance with various embodiments. At Block 304, trend data is accessed for one or more of news, events, social media, and Internet searches. This may be done, for example, by utilizing services and software such as, but not limited to, Google® Trends™. At Block 308, keywords are extracted or generated from the trend data, as discussed in detail above with reference to FIG. 2. With reference back to FIGS. 1 and 2, this function may be performed by server 120 or keyword extractor 212, which may be implemented on server 120. The keywords may optionally be stored in keyword storage 216 (Block 312), which may be implemented as a database server that is local or remote to server 120. Keywords stored in a database server may be stored in any manner known in the art that allows for comparison of the keywords with search terms. The keyword storage 216 may alternatively be implemented as a memory bank (e.g., RAM, disc drive, flash drive, solid-state drive, etc.), in which a text document or otherwise word-searchable document would serve as the medium in which the keywords or list of terms are stored.

Utilizing the extracted or generated keywords from Block 308, content libraries—such as local content library 236 or remote content library 228—may be searched (Block 316), by searching, e.g., the respective content catalogs—such as local content catalog 232 or remote content catalog 224 for terms that match, are similar to, and/or are related to the extracted keywords. In some embodiments, searching for similar and/or related terms may include searching for root words (for example, searching for “view,” which is a root word of “viewing” or “views”) or synonyms (for example, searching for “view,” which is a synonym of “watch,” “perceive,” or “see”).

At Block 320, a list of relevant multimedia content (e.g., video, audio, and/or written content) may be generated. The list may be embodied as a string of characters (or binary equivalent thereof), or as a list of characters in a word-searchable document. The generated list may optionally be stored (Block 324)—as the string of characters or as a word-searchable document—in a database (not shown) that is local or remote to the server 120 or other channel-generating server. In some embodiments, this database may be database 216, which is used to store the generated or extracted keywords. At Block 328, the relevant multimedia content is retrieved from the content libraries based on the generated list (which may indicate which content library holds each of the relevant multimedia content). Retrieval of the relevant multimedia content may include following a pointer or other reference marker to the location of the local and/or remote content libraries 228/236, then saving a copy of the relevant multimedia content in a working buffer (e.g., RAM of server 120). Retrieval of the content is not so limited, and may include any known method known to those skilled in the art.

The multimedia content, at Block 332, is then formatted or rendered for presentation to a user, such as by formatter 248 in a manner as discussed above. At Block 336, the formatted multimedia content is subsequently output to the user devices 132, 136, 140, 144, 148, or 260 via content presentation/distribution systems 256 (as embodied, e.g., by network 124, broadcast distribution center 128a, and/or transmission tower 128b, or by any other distribution system (not shown)). In some embodiments, content presentation/distribution system 256 converts the formatted multimedia content into digital data packets that are transmitted via network 124 and via telecommunications transport media (e.g., cable, xDSL, etc.) in any manner known in the art. In the case of broadcast, the formatted multimedia content may be converted into analog or digital data signals that are transmitted via broadcast media (e.g., radio or satellite, etc.).

At the user devices 260, the multimedia content is transcoded for display or presentation (at Block 340). In some embodiments, transcoding includes converting the formatted multimedia content from the digital data packets, or from the analog/digital data signals, back into a format that is readable by the one or more user devices, and subsequently displaying/presenting the converted and formatted multimedia content on the display screen and/or speakers of the one or more user devices.

With reference to FIGS. 4A-4C, a system flow diagram 400 is shown illustrating the processes performed at or by components of the system in order to generate and present an automated social media and event driven multimedia channel, which can be used in accordance with various embodiments. The steps in FIG. 4A continue onto FIG. 4B, linked by the circular marker denoted by “A.” Similarly, the steps in FIG. 4B continue onto FIG. 4C, linked by the circular marker denoted by “B.”

At Block 404, news events, social media, and Internet searches, etc. are accessed from the Internet, and trend data is generated, at Block 408, based on top news, events, social media, Internet searches, etc. that are accessed in Block 404. Blocks 404 and 408, which are shown as dashed box diagrams in FIG. 4A, may be implemented as part of various embodiments (e.g., by trend data server 112 in FIG. 1) or may be performed by third party services or programs such as Google® Trends™ or other similar services. At Block 412, the trend data is accessed from the Internet, such as from a trend data server 112 (as shown in FIG. 1).

On the server (such as server 120 in FIG. 1), keywords are generated based on the trend data (at Block 416) in a manner as discussed above with reference to FIGS. 2 and 3, and may optionally be stored in a local database or DB (such as keyword storage 216 in FIG. 2) (at Block 420). At Block 424, the Internet (such as network 104 or 204 in FIGS. 1 and 2; at Block 424a), the local content catalog (such as catalog 232 in FIG. 2; at Block 424b), or the remote content catalog (such as catalog 224 in FIG. 2; at Block 424c) are searched using the generated keywords from Block 416. Based on the search results, a list of the relevant multimedia content (i.e., video, audio, and/or written content) is generated, at Block 428, in a similar manner as in Block 320.

Continuing onto FIG. 4B, a determination is made at Block 432 as to whether the relevant multimedia content is to be broadcast or not. If not, the process proceeds to Block 464 in FIG. 4C. If so, a programming schedule is generated at Block 436, based on the list generated in Block 428. In some embodiments, the programming schedule is also based on a set of predetermined criteria, which may include, but are not limited to, at least one of relevance, user preference, popularity, age of viewers, length of multimedia content, subject matter of multimedia content, and broadcaster's program scheduling policies. For example, for sports content, if the users are known to include a family with children, who are interested in college football, the programming schedule may be generated to take this fact into consideration by scheduling broadcast of more video and audio clips compared to textual clip, with these clips being scheduled to be broadcast during a time in the day that the family is likely to be home and awake (e.g., on a Sunday afternoon), where such broadcasts do not conflict with network broadcasts of the actual college football games. As such, it may be necessary to cross-reference traditional broadcast schedules in order to determine whether there is a conflict, and to schedule or re-schedule the broadcast of the clips accordingly. In one aspect, the programming schedule might be created as a playlist, so that, for example, the user can select a clip or the playlist to play through one clip to the next.

Determinations at Blocks 440a, 440b, and 440c are then made to locate the relevant content on the Internet, the local DB, and the remote DB, respectively. This functionality may be implemented by looking up the generated list (for the embodiments in which the generated list includes the locations where the relevant content are stored). Alternatively, Blocks 424a, 424b, and 424c may be repeated. Because the generated list from Block 428 is based on a determination that the relevant content is located in at least one of the Internet, the local DB, and the remote DB, if it is determined at Blocks 440a, 440b, or 440c that one or two of these locations do not contain the relevant content, then a determination is made whether the other location(s) contains the relevant content. Based on the location determinations at Blocks 440a, 440b, and 440c, the relevant content is retrieved from the Internet (at Block 444a), the local DB (at Block 444b), and/or the remote DB (at Block 444c). Retrieval of the relevant multimedia content may include following a pointer or other reference marker to the location of the local and/or remote content libraries 228/236, then saving a copy of the relevant multimedia content in a working buffer (e.g., RAM of server 120 or an external/internal content delivery network (“CDN”)). Retrieval of the content is not so limited, and may include any known method known to those skilled in the art. In some embodiments, the system might extract the key words, and/or search for content based on the keywords, e.g., (a) by searching in a service provider's library, and/or (b) by searching external content sources (e.g., Hulu®, YouTube®, or other Internet sites). As appropriate, the system might create links to relevant content via a uniform resource identifier (“URI” which can includes a uniform resource locator (“URL”) and/or a uniform resource name (“URN”)), URL/content name, Internet Protocol (“IP”) address, location/filename, and/or URI/filename.

At Block 448, a dynamic automated broadcast channel or a set of channels is generated based on the retrieved relevant video, audio, and/or written content, and based on predetermined criteria. The predetermined criteria may include, but are not limited to, at least one of relevance, user preference, popularity, age of viewers, length of multimedia content, subject matter of multimedia content, and broadcaster's program scheduling policies. Alternatively, or in addition, a playlist(s) of the retrieved relevant video, audio, and/or written content is generated. Here, the playlist may refer to one of a list of content to be broadcast, a list with links (e.g., hyperlinks or pointers) to the content to be broadcast, and an ordered arrangement of the actual content to be broadcast. The relevant content to be broadcast (the “broadcast content”) or the playlist is then formatted at Block 452 for display or presentation on the user device (such as one or more user devices 260 in FIG. 2). At Block 456, the channel(s) or playlist(s) is broadcast via the broadcast center 128a, the ISP network 124 (which, as noted above, can include a cable network, or some other content presentation system 256). The broadcast channel(s) or playlist(s) is received and displayed/presented on the one or more user devices (such as user devices 132, 144, and 148 in FIG. 1 or user devices 260 in FIG. 2).

If the determination at Block 432 is made that the content is not to be broadcast, then the process shifts to the steps related to on-demand channel generation as shown in FIG. 4C. Alternatively, according to some embodiments, the same particular set of relevant content may be both broadcast and streamed as on-demand content, in which case, the system might perform the operations of FIGS. 4B and 4C, respectively, sequentially and/or in parallel for the same particular set of content.

Turning to FIG. 4C, an on-demand selection screen is generated at the server (at Block 464a), e.g., based on the list generated at Block 428. At Block 464b, the generated selection screen is then streamed via ISP network 124, broadcast distribution system 128, content presentation system 256, and/or a content distribution system (e.g., a CDN). The selection screen is displayed on one or more user devices 132, 144, 148, and 260 (at Block 464c). The selection screen may be presented in any suitably interactive manner. For example, following the trends related to singer/actress Whitney Houston, a selection screen may be populated with images of the singer, images representing links to video clips of the singer, audio clips of her songs, and/or comment boxes, or links to comment boxes, containing online or news articles regarding the singer/actress (e.g., including news of her tragic death). In terms of layout of the selection screen, the relevant content may be suitably arranged. For example, video clips may be arrayed together, audio clips may be arranged as a group, written content may likewise be grouped together, or all of these clips may be distributed randomly, or according to some predetermined pattern, on the selection screen(s). Alternatively, a collage-like smattering of the video, audio, and/or textual clips may fill the selection screen. The selection screen may span several pages or across a scrollable page. Regardless of the format of the selection screen, interactive links would be provided for each video, audio, and/or textual clip so that a user may select to have the video, audio, and/or textual clip presented on the user device. At Block 468, the user device(s) receives the user selection of the one or more video, audio, and/or textual clips. The selection screen may also provide the user with the capability to create a playlist of the video, audio, and/or textual clip, the order of which the user can rearrange at will (as part of the user selection).

The selection screen, as discussed above, represents part of a user interface, which can function to receive input from a user, e.g., using standard input devices such as remote controllers (e.g., for one or more of the television sets 144, for STB 140, for gaming console 136, or for personal/laptop computer 132, etc.), mice and other pointing devices (e.g., a stylus for mobile devices 148), motion capture devices (e.g., an image capture device such as the Xbox® Kinect® or PlayStation Move®, or gyroscopically-driven or accelerometer-driven game controllers such as the PlayStation® Sixaxis® controllers or Wii Remote®, etc.), touchpads and/or touchscreens, keyboards (e.g., numeric and/or alphabetic), microphones, etc. The procedures undertaken to provide a user interface, therefore, can vary depending on the nature of the implementation; in some cases, providing a user interface can comprise displaying the user interface on a display device; in other cases, however, in which the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device. Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML/HTML5 and/or AJAX technologies, to name but a few examples.

In many cases, providing a user interface will comprise providing one or more display screens (not shown), each of which includes one or more user interface elements. As used herein, the term “user interface element” (also described as a “user interface mechanism” or a “user interface device”) means any text, image, or device that can be displayed on a display screen for providing information to a user and/or for receiving user input. Some such elements are commonly referred to as “widgets,” and can include, without limitation, text, text boxes, text fields, tables and/or grids, menus, toolbars, charts, hyperlinks, buttons, lists, combo boxes, checkboxes, radio buttons, and/or the like. While any illustrated exemplary display screens might employ specific user interface elements appropriate for the type of information to be conveyed/received by computer system in accordance with the described embodiments, it should be appreciated that the choice of user interface elements for a particular purpose is typically implementation-dependent and/or discretionary. Hence, the illustrated user interface elements employed by any display screens described herein should be considered exemplary in nature, and the reader should appreciate that other user interface elements could be substituted within the scope of various embodiments.

As noted above, in an aspect of certain embodiments, the user interface provides interaction between a user and a computer or interactive television system. Hence, when this document describes procedures for displaying (or otherwise providing) information to a user, or to receiving input from a user, the user interface may be the vehicle for the exchange of such input/output. Merely by way of example, in a set of embodiments, the user interface allows the user to select video, audio, and/or textual clip(s) for inclusion in an on-demand channel(s) generated for display or presentation on one or more user devices, as well as allowing the user to choose the order or arrangement of the selected video, audio, and/or textual clips within the generated on-demand channel(s).

Based on the user selection, at Block 472, in accordance with the discussion above, the generated list from Block 428 is searched for the selected content. At Blocks 476a, 476b, and 476c, determinations are made in order to locate the selected content from one or more of the Internet (Block 476a), the local DB (Block 476b), and the remote DB (Block 476c)—in the same manner in which the determinations at Blocks 440a, 440b, and 440c are made, as discussed above. Based on the location determinations at Blocks 476a, 476b, and 476c, the relevant content is retrieved from the Internet (at Block 480a), the local DB (at Block 480b), and/or the remote DB (at Block 480c).

At Block 484, a dynamic automated on-demand channel or a set of channels is generated based on the retrieved relevant video, audio, and/or written content. Alternatively, or in addition, a playlist(s) of the retrieved relevant video, audio, and/or written content is generated. Here, the playlist may refer to one of a list of content to be streamed, a list with links (e.g., hyperlinks or pointers) to the content to be streamed, and an ordered arrangement of the actual content to be streamed. The relevant content to be streamed (the “on-demand content”) or the playlist is then formatted at Block 488 for display or presentation on the user device (such as one or more user devices 260 in FIG. 2). At Block 492, the channel(s) or playlist(s) is streamed via the broadcast center 128a, the network 124, or some other content presentation system 256. The on-demand channel(s) or playlist(s) is received and displayed/presented on the one or more user devices (such as user devices 132, 144, and 148 in FIG. 1 or user devices 260 in FIG. 2). In some embodiments, the process may return to marker “B,” where Blocks 464-496 may be repeated.

Referring back to the Whitney Houston example, in Blocks 484 through 496, the generated on-demand channel would be generated (at Block 484) with the user selected video, audio, and/or textual clips of the singer/actress, arranged in the order indicated by the user at Block 468. The selected video, audio, and/or textual clips of the singer/actress would then be formatted for display or presentation on one or more user devices that are associated with the user; for example, IPTV 144b, laptop computer 132b, tablet computer 148c, and smartphone 148b may be associated with the user, in which case, the formatting step would allow for optimal presentation on each of these associated user devices. At Blocks 492 and 496, the generated on-demand channel containing the selected video, audio, and/or textual clips of the singer/actress, in the preferred order (which may be changed mid-stream of the channel streaming), can be streamed and presented/displayed on the associated user devices.

Alternative, or in addition, to the streamed on-demand channel of Whitney Houston, a playlist of the selected content may be generated at Block 484, and formatted, streamed, and displayed at Blocks 488-496. The playlist may be displayed concurrent with the generated on-demand channel, for example, as an overlaid program guide or an overlaid interactive menu listing in which the order of the selected content may be changed at will by the user. The overlaid guide may also allow for the user to add or delete content from the playlist. Alternative to the overlaid guide is a band that would appear at the top, bottom, left side, or right side of the displayed channel that allows for display of the playlist (together with the interactive re-ordering, adding, and/or deleting functionalities). After the content on the playlist has been streamed, the process may return to Block 464a, where another selection screen is generated. Blocks 464b through 496 may thus be repeated. In the case that the user no longer wants to view, listen to, and/or read content about Whitney Houston, an option in the selection screen may allow the user to return to Block 404.

In the embodiments in which multiple channels (whether broadcast or on-demand) are generated, one channel could relate to, e.g., Whitney Houston, while another channel(s) might relate to, e.g., Sunday's football game, while a third set of channels might relate to, e.g., the most talked about television program or movie of the season. The user would be able to switch channels in the same manner as he or she would with conventional television channels. Options may be provided for the user to create other specialized channels. These channels may be provided as part of the television/cable subscription package, as a stand-alone package, or as a pay-per-view type package.

In some embodiments, the user may select a period on which the trend data may be based. Such a period may extend backwards in time from a current time, by any number of seconds, minutes, hours, days, weeks, months, or years. Alternatively, the period may be any user-defined period (e.g., between two user-selected dates).

According to some embodiments, the trend data, upon which the on-demand and broadcast channels are ultimately based, may be generated based upon a user database containing preferences of the user. Such a user database may be configured to track—with the user's permission—the user's social media postings and/or Internet searches with respect to contemporary news, events, or user interests, in order to generate keywords for seeking relevant content and generating tailored on-demand or broadcast channels. In these embodiments, the resultant channels may be provided as part of the television/cable subscription package, as a stand-alone package, or as a pay-per-view type package.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A method for compiling video content for presentation in dynamic automated content channels to a user, the method comprising:
accessing, at a head-end of a telecommunications system, trend data from a trend database, wherein the trend data represents contemporary social media, Internet searches, or news events;
generating, at the head-end, keywords based on the trend data;
storing, at the head-end, the generated keywords in a keyword database;
searching, at the head-end, at least one content catalog of at least one content library for video content that is relevant to the generated keywords;
generating, at the head-end, a list of relevant video content based on the search of the at least one content catalog;
generating, at the head-end, at least one dynamic automated on-demand channel for streaming the relevant video content, based on the list of relevant video content, wherein the head-end is configured to display a selection screen on the at least one dynamic automated on-demand channel from which the user is enabled to select a program of the relevant video content for streaming;
generating, at the head-end, at least one dynamic automated broadcast channel associated with the relevant video content based on the at least one content catalog, wherein the head-end is configured to generate a programming schedule of the relevant video content based on predetermined criteria and to broadcast the relevant video content to a plurality of users on the at least one dynamic automated broadcast channel based on the generated programming schedule, wherein the predetermined criteria include at least one criterion selected from the group consisting of relevance, user preference, popularity, age of viewers, length of video content, subject matter of video content, and broadcaster's program scheduling policies;
formatting, at the head-end, the program of relevant video content and the broadcast relevant video content for presentation on at least one user device, wherein the at least one user device includes at least one of a cable television system, an interactive television system, a standard television system, a gaming console, a mobile device, a personal computer, and a tablet computer; and
providing, at the at least one user device and selectable by user input, user access to one or more of the at least one dynamic automated on-demand channel and the at least one dynamic automated broadcast channel, the dynamic automated on-demand channel presenting the program of relevant video content and the dynamic automated broadcast channel presenting the broadcast relevant video content.

2. A method for compiling multimedia content for presentation in dynamic automated content channels to a user, the method comprising:
accessing, at a server of a telecommunications system, trend data from a trend database;
generating, at the server, keywords based on the trend data;
searching, at the server, at least one content catalog of at least one content library for multimedia content that is relevant to the generated keywords;
generating, at the server, at least one dynamic automated content channel on which the relevant multimedia content is presented;
providing, at one or more user devices associated with the user, user access to the at least one dynamic automated content channel; and
generating, at the server, at least one dynamic automated broadcast channel associated with the relevant video content based on the at least one content catalog, wherein the head-end is configured to generate a programming schedule of the relevant video content based on predetermined criteria and to broadcast the relevant video content to a plurality of users on the at least one dynamic automated broadcast channel based on the generated programming schedule, wherein the predetermined criteria include at least one criterion selected from the group consisting of relevance, user preference, popularity, age of viewers, length of video content, subject matter of video content, and broadcaster's program scheduling policies.

3. The method of claim 2, wherein the multimedia content includes at least one of video content, audio content, and written content formatted as a video on-demand stream or a video broadcast.

4. The method of claim 2, wherein the server of a telecommunications system includes at least one of a server located at a head-end of the telecommunications system, a server located external to the head-end that is communicatively coupled to the head-end, a server located at a broadcast television distribution system, and a server located external to the broadcast television distribution system that is communicatively coupled to the broadcast television distribution system.

5. The method of claim 2, wherein the trend data represents one or more of contemporary social media, Internet searches, and news events.

6. The method of claim 2, wherein the trend database includes an Internet trend generating database that compiles popularity trends of contemporary social media, Internet searches, or news events based on data compiled from on-line interactions of a plurality of users on the Internet during a predetermined period.

7. The method of claim 6, wherein the predetermined period extends backwards in time from a current time, by seconds, minutes, hours, days, weeks, months, or years.

8. The method of claim 6, wherein the predetermined period includes a user-defined period.

9. The method of claim 2, wherein the trend database includes a user database comprising preferences of the user.

10. The method of claim 9, wherein at least some of the preferences are generated automatically based on personal interactions of the user with social media and the Internet, with respect to contemporary news, events, or user interests.

11. The method of claim 2, further comprising:
storing, at the server, the generated keywords in a keyword database.

12. The method of claim 2, wherein the at least one content library includes at least one remote content library that is located external to the server and at least one local content library that is located at the server, wherein the at least one remote content library includes one or more of the Internet, a database server, and an archive, wherein the at least one local content library includes a database.

13. The method of claim 2, further comprising generating, at the server, a list of relevant multimedia content based on the search of the at least one content catalog, wherein generating the at least one dynamic automated content channel is based on the list of relevant multimedia content.

14. The method of claim 2, wherein the at least one dynamic automated content channel includes at least one on-demand channel, wherein the server is configured to display a selection screen on the at least one on-demand channel from which the user is enabled to select one or more of the relevant multimedia content for presentation on the at least one on-demand channel.

15. (canceled)

16. The method of claim 2, wherein the predetermined criteria include at least one of relevance, user preference, popularity, age of viewers, length of multimedia content, subject matter of multimedia content, and broadcaster's program scheduling policies.

17. The method of claim 2, further comprising:
formatting, at the server, the relevant multimedia content for presentation on the one or more user devices, wherein the one or more user devices include at least one of a cable television system, an interactive television system, a standard television system, a gaming console, a mobile device, a personal computer, and a tablet computer, and wherein the at least one dynamic automated content channel is configured to present the relevant multimedia content that is formatted for presentation on the user device.

18. The method of claim 2, further comprising:
identifying one or more user devices that are associated with the user;
retrieving the relevant multimedia content from the at least one content library;
formatting the retrieved relevant multimedia content based on characteristics of the identified one or more user devices; and
storing the formatted relevant multimedia content in a server, wherein:
generating the at least one dynamic automated content channel includes retrieving the formatted relevant multimedia content from the server and compiling the formatted relevant multimedia content for presentation on the one or more user devices,
wherein providing user access to the at least one dynamic automated content channel includes enabling the one or more user devices to receive the at least one dynamic automated content channel and transmitting the at least one dynamic automated content channel to the one or more user devices.

19. A system for compiling multimedia content for presentation in dynamic automated content channels to a user, the system comprising:
a server at a telecommunications system configured to:
access trend data from a trend database;
generate keywords based on the trend data;
search at least one content catalog of at least one content library for multimedia content that is relevant to the generated keywords;
format at least one of the relevant multimedia content for presentation on one or more user devices; and
generate at least one dynamic automated broadcast channel associated with the relevant video content based on the at least one content catalog, wherein the head-end is configured to generate a programming schedule of the relevant video content based on predetermined criteria and to broadcast the relevant video content to a plurality of users on the at least one dynamic automated broadcast channel based on the generated programming schedule, wherein the predetermined criteria include at least one criterion selected from the group consisting of relevance, user preference, popularity, age of viewers, length of video content, subject matter of video content, and broadcaster's program scheduling policies; and
a transmission system in communication with the server and configured to:
transmit the at least one dynamic automated content channel to the one or more user devices for presentation of the relevant multimedia content to the user.
